(19) United States
(12) Patent Application Publication
(10) Pub. No.: US 2016/0155137 A1
(43) Pub. Date: Jun. 2, 2016

(54) DEMAND FORECASTING IN THE PRESENCE OF UNOBSERVED LOST-SALES

(71) Applicant: International Business Machines Corporation, Armonk, NY (US)

(72) Inventors: Pavithra Harsha, White Plains, NY (US); Shivaram Subramanian, New Fairfield, CT (US)

(21) Appl. No.: 14/556,294

(22) Filed: Dec. 1, 2014

(51) Int. Cl. G06Q 30/02

(52) U.S. Cl. CPC G06Q 30/0202

(57) ABSTRACT

A demand forecasting system includes a market information processing module that processes a historical sales dataset to provide a lost market rate probability dataset, a lost-sales forecasting module that processes the lost market rate probability dataset to provide a lost-sales dataset, a market size forecasting module that processes the lost market rate probability dataset to provide a market size dataset as a function of the lost market rate probability, a demand forecasting module that processes the lost-sales dataset and the historical sales dataset to provide a demand dataset and a market share dataset as functions of the lost-sales dataset and the historical sales dataset and a best fit optimization module that processes the market size dataset and the market share dataset to provide a set of best fit parameters for the market size and the market share or the demand. A corresponding method is also described.

### BACKGROUND OF THE INVENTION

The present invention relates to systems for processing sales related data. Demand forecasting is an important process for a seller supplying one or more commodities in a marketplace. It enables the seller to make educated decisions related to a commodity regarding such things as inventory and price sensitivity. Forecasting demand is typically achieved via regression or maximum likelihood based methods over the observed sales for each of the commodities being supplied and the arrival rate. The arrival rate represents the number of people who consider purchasing the commodity in a particular timeframe. Current systems for forecasting demand are organized in a manner such that the quality of the result cannot be guaranteed.

### SUMMARY

As disclosed herein, a system for forecasting demand comprises a data retrieval module configured to retrieve a historical sales dataset and corresponding sales attributes dataset for one or more sellable commodities as well as a functional form dataset for determining a market size model and a market share model, a market information processing module configured to process the historical sales dataset to provide a lost market rate probability dataset, a lost-sales forecasting module configured to process the lost market rate probability dataset to provide a lost-sales dataset as a function of the lost market rate probability, a market size forecasting module configured to process the lost market rate probability dataset to provide a market size dataset as a function of the lost market rate probability, and a demand forecasting module configured to process the lost-sales dataset and the historical sales dataset to provide a demand dataset and a market share dataset as functions of the lost-sales dataset and the historical sales dataset. The system may further comprise a best fit optimization module configured to process the market size dataset and the market share dataset to provide a set of best fit parameters for the market size and the market share or the demand. The system may further comprise a data presentation module configured to present datasets to one or more users.

A method that invokes the above mentioned modules is also disclosed herein, the method comprising retrieving a historical sales dataset and a corresponding sales attributes dataset for one or more sellable commodities, retrieving a functional form dataset for determining a market size dataset and a market share dataset for the set of sellable commodities, processing the historical sales dataset to provide a lost market rate probability dataset for the set of sellable commodities, processing the lost market rate probability dataset to provide a market size dataset and a lost-sales dataset as functions of the lost market rate probability for the set of sellable commodities, and processing the lost-sales dataset and the historical sales dataset to provide a demand dataset and a market share dataset as functions of the lost-sales and the historical sales for the set of sellable commodities. The method may also include processing the market size dataset and the market share dataset and/or the demand dataset to provide a best fit parameters dataset for the market size and the market share and/or the demand for the set of sellable commodities.

### BRIEF DESCRIPTION OF THE DRAWINGS

FIG. 1 is a module architecture diagram depicting one embodiment of a demand forecasting system;

FIG. 2 is a flowchart depicting one embodiment of a module invocation method;

FIG. 3 is an operation dependency diagram for various modules depicted in FIG. 1 including at least one embodiment of a lost-sales forecasting module and at least one embodiment of a market size forecasting module;

FIG. 4 is an operation dependency diagram for various modules depicted in FIG. 1 including at least one embodiment of a demand forecasting module; and

FIG. 5 is an equation diagram depicting one embodiment of a best fit optimization algorithm that may be executed by at least one embodiment of a best fit optimization module depicted in FIG. 1.

### DETAILED DESCRIPTION

One of skill in the art will recognize that a programmable digital processing apparatus such as a so called ‘general purpose’ computer, or a portion thereof, is no longer a general purpose device when the digital processing apparatus executes software (or other forms of programming codes) to perform a particular function. Furthermore, one of skill in the art of computer engineering and/or digital logic design will appreciate that nearly all modern hardware is programmable and/or synthesized from logic expressions using a programming language including ‘high level’ programming languages such as C++. Such programming of hardware previous to manufacture is often referred to as algorithmic synthesis or behavioral synthesis.

Programming of a digital processing apparatus to perform specific functions may also take place after manufacture. For example, fuses may be blown or logic cells may be configured by applying programming signals to an integrated circuit. Is some cases, such devices may only be programmed once. In other cases, the devices are reprogrammable. For example, such devices may contain, or have access to, distributed or centralized memory arrays that configure logic gates or processors.

The embodiments disclosed herein recognize that standard processing systems for forecasting demand for sellable commodities in the presence of lost-sales require historical information about the sellable commodity, and also require an estimate for market size or arrival rate that is fairly accurate. However, these systems are unable to produce reliable results when the lost-sales are unobserved and the arrival rate is unknown. Recently proposed estimation systems fail to find a global maximum because their best fit optimization scenarios are not globally concave. Consequently, their deployments are practically limited by run-time performance issues because of the need to re-run the procedure several times to increase the chances of finding good quality solutions. Furthermore, when the richness of historical data required for system calibration (e.g. sales, number of commodities, and a plurality of commodity attributes) is significant, the number of numerical forecast parameters to be estimated is also significant. In addition, several of these coefficients may have user-defined ranges or be subject to logical constraints. In such scenarios, heuristic variations have to be employed that can result in scalability issues, significantly degrading the practical applicability of systems employing such modules. In contrast, the systems disclosed herein generate best fit optimization scenarios that are globally concave. Therefore, the resultant data can be guaranteed to be accurate within a user selected error range.

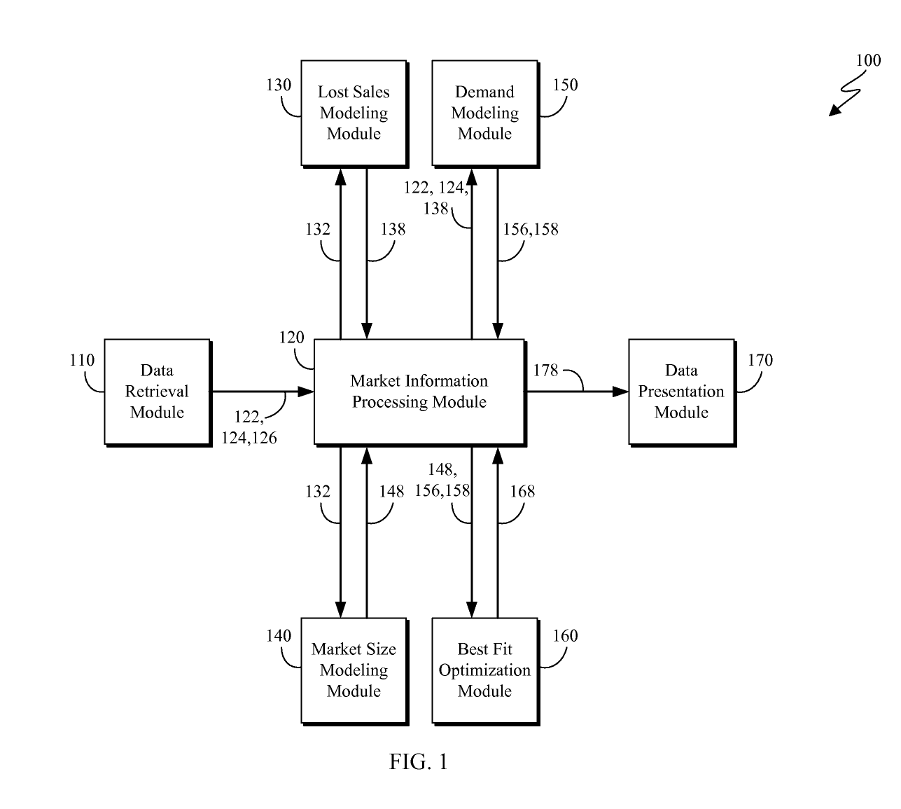

FIG. 1 is a module architecture diagram depicting one embodiment of a demand forecasting system 100. As depicted, the demand forecasting system 100 includes a data retrieval module 110, a market information processing module 120, a lost-sales forecasting module 130, a market size forecasting module 140, a demand forecasting module 150, a best fit optimization module 160, and a data presentation module 170. The dataflow diagram of FIG. 1 also depicts the directions in which datasets travel within the system 100. Each direction is labeled to denote which datasets travel along each data pathway.

The data retrieval module 110 may be configured to retrieve data. The data may be retrieved from one or more data sources (not shown) via a network, intra-network, or inter-network. Examples of data sources include relational databases like IBM DB2 when the original data is readily available in a structured time-series format. When components of the original data are unstructured (e.g. social media buzz on social networking websites, or customer product ratings on e-commerce portals) the data has to be first acquired, and transformed into structured time-series data using computational tools like IBM-Social Media Analytics and then loaded into such databases. In some embodiments, the data retrieval module 110 is configured to retrieve a historical sales dataset 122 and a corresponding sales attributes dataset 124 for one or more sellable commodities. The data retrieval module 110 may also be configured to retrieve a functional form dataset 126 for determining a market size model and/or a market share model for a set of sellable commodities comprising one or more sellable commodities.

The market information processing module 120 may be configured to process the historical sales dataset 122 to provide a lost market rate probability dataset 132 for the set of sellable commodities. In some embodiments, the market information processing module 120 is also configured to distribute datasets to the lost-sales forecasting module 130, the market size forecasting module 140, the demand forecasting module 150, the best fit optimization module 160, and the data presentation module 170. In these embodiments, the market information processing module 120 is additionally configured to receive and distribute datasets regarding lost-sales, market size, demand, market share, and best fit optimization parameters.

The lost-sales forecasting module 130 may be configured to process the lost market rate probability dataset 132 to provide a lost-sales dataset 138 that indicates lost-sales as a function of the lost market rate probability for the set of sellable commodities. In some embodiments, the lost-sales forecasting module 130 is configured to receive the lost market rate probability dataset 132. Upon processing the lost market rate probability dataset 132, the lost-sales forecasting module 130 may provide a lost-sales dataset 138.

The market size forecasting module 140 may be configured to process the lost market rate probability dataset 132 and provide a market size dataset 148 as a function of the lost market rate probability for the set of sellable commodities. In some embodiments, the market size forecasting module 140 is configured to receive the lost market rate probability dataset 132. Upon processing the lost market rate probability dataset 132, the market size forecasting module 140 may provide a market size dataset 148.

The demand forecasting module 150 may be configured to process the lost-sales dataset 138 and the historical sales dataset 122 to provide a demand dataset 156 and a market share dataset 158 for the set of sellable commodities. The demand forecasting module 150 may additionally be configured to process the sales attributes dataset 124 to provide a demand dataset 156 and a market share dataset 158. Upon processing the historical sales dataset 122 and the lost-sales dataset 138, the demand forecasting module may provide a demand dataset 156 and a market share dataset 158.

The best fit optimization module 160 may be configured to process the market size dataset 148 and the market share dataset 158 and/or the demand dataset 156. Processing these datasets may provide a best fit parameters dataset 168 for the market size and the market share and/or the demand for the set of sellable commodities. Upon processing the market size dataset 148 and the market share dataset 158 and/or the demand dataset 156, the best fit optimization module 160 may provide a best fit parameters dataset 168.

The data presentation module 170 may be configured to present the datasets it receives to one or more users. For example, the data presentation module 170 may enable graphical or textual perusal of various datasets 178 by one or more users. The datasets 178 the data presentation module 170 presents may include the lost-sales dataset 138, the market size dataset 148, the market share dataset 158, the demand dataset 156, the best fit parameters dataset 168, the historical sales dataset 122, or the sales attributes dataset 124.

The following figures include a number of operation dependency diagrams that show the execution dependencies for various operations conducted by the modules depicted in FIG. 1. One of skill in the art will appreciate that the following dependency diagrams enable one of skill in the art to structure a computing system comprising one or more digital processing devices in a manner that optimizes performance of the system of FIG. 1.

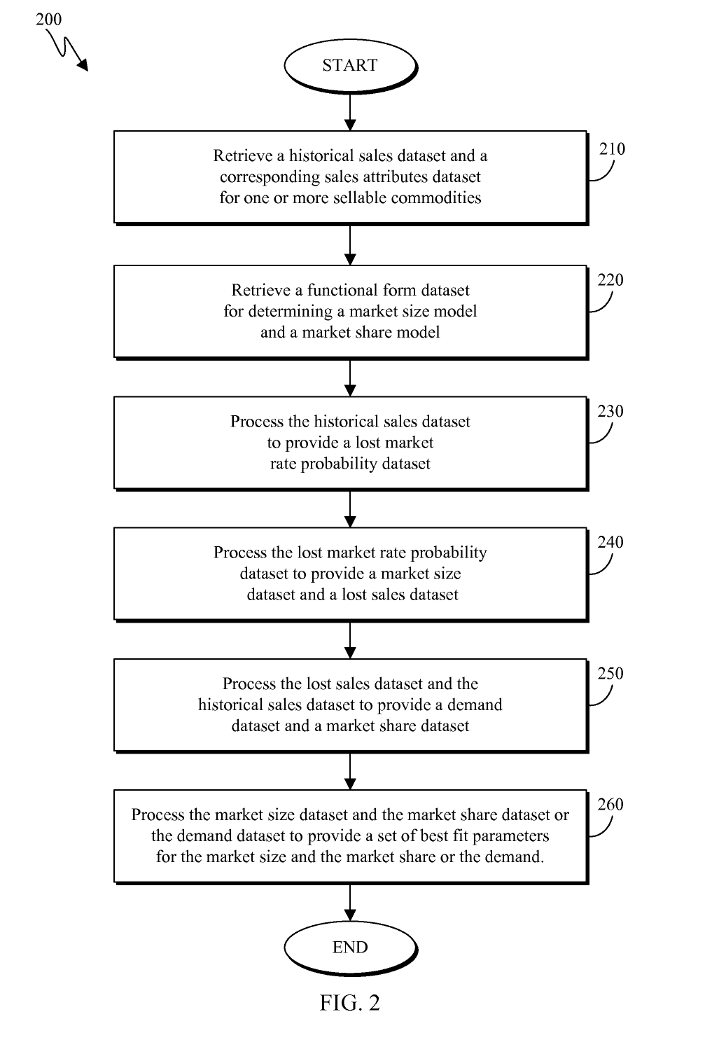

FIG. 2 is a flowchart depicting one embodiment of a module invocation method 200. As depicted, the module invocation method 200 includes retrieving a historical sales dataset and a corresponding sales attributes dataset 210 for one or more sellable commodities, retrieving a functional form dataset 220 for determining a market size dataset and a market share dataset for the set of sellable commodities, processing the historical sales dataset 230 to provide a lost market rate probability dataset for the set of sellable commodities, processing the lost market rate probability dataset 240 to provide a market size dataset and a lost-sales dataset as functions of the lost market rate probability for the set of sellable commodities, and processing the lost-sales dataset and the historical sales dataset 250 to provide a demand dataset and a market share dataset as functions of the lost-sales and the historical sales for the set of sellable commodities. The method may also include processing the market size dataset and the market share dataset and/or the demand dataset 260 to provide a best fit parameters dataset for the market size and the market share and/or the demand for the set of sellable commodities. The demand forecasting method may be used to provide a seller with insight regarding inventory and price sensitivity decisions.

Retrieving a historical dataset and corresponding sales attributes dataset 210 may include activating the data retrieval module 110 to retrieve datasets. The retrieved datasets may include a historical sales dataset 122 and a corresponding sales attributes dataset 124 for one or more sellable commodities. The historical sales dataset 122 may comprise data corresponding to the number of sales made in the past and at what prices each commodity was sold. The corresponding sales attributes dataset 124 may include additional sales related information such as promotional events and seasonality. In certain embodiments, the historical sales dataset 122 includes some incomplete or aggregate information on lost-sales data. In many embodiments, however, lost-sales data is absent. In some embodiments, the historical sales dataset 122 does not include one or more sales observations for one or more consumer commodities. The historical sales dataset 122 may include sales data for a group of customer choices that are substitutes, complements, or correlated commodities that have similar product attributes.

Retrieving a functional form dataset 220 may include activating the data retrieval module 110 to retrieve a functional form dataset 126. The functional form dataset 126 may include specifications regarding what type of models should be used for the market size and the market share. The demand forecasting method allows for modeling a variety of functional forms, but for executing a specific instance the market size and the market share must each be set to have a particular form. For example, in one embodiment the market size can be a log-linear model and the market share can be a multinomial logit model.

Processing the historical sales dataset 230 may include using a market sales information module 120 to perform global optimization of the lost market rate probability over a bounded space. Processing the historical sales dataset 230 may provide a lost market rate probability dataset 132 for the set of sellable commodities. Lost market rate probability refers to the likelihood that the market share will decrease by a certain amount. In some embodiments, providing a dataset for lost market rate probability includes modeling the lost market rate probability as an SOS2 variable. For example, the set of possible lost market rate values in the interval [0,1) may be represented as F_{K} such that K is the total number of lost market rate values and fₖ represents the k^{th} value in the set F_{K} where k is between 1 and K. Selecting a higher K value leads to finer granularity in the global optimization process and therefore a decreased maximum error. In other embodiments, the lost market rate probability is obtained using a hard-maximum approximation of the market-share, where the log(lost market rate)=negative of the maximum attractiveness of a consumer choice.

Processing the lost market rate probability dataset 240 may include using a lost-sales forecasting module 130 and a market size forecasting module 140 to provide a lost-sales dataset 138 and a market size dataset 148, respectively. In some embodiments, the market size and the lost-sales are modeled as piecewise linear functions of the lost market rate probability. The lost-sales may include sales lost as a result of a customer purchasing another commodity from a different seller or the customer not purchasing anything at all.

Processing the lost-sales dataset and the historical sales dataset 250 may include activating a demand forecasting module 150 to use the historical sales dataset 122 and the lost-sales dataset 138 as inputs for a demand equation. Processing 250 may also include using the demand forecasting module 150 to provide a demand dataset 156 and a market share dataset 158 for the set of sellable commodities. The demand dataset 156 may comprise a plurality of demand values and the market share dataset 158 may comprise a plurality of market share values. Together, steps 240 and 250 may identify the missing sales values for the set of sellable commodities for any lost market rate probability. This enables imputation of missing sales values for periods where only partial sales were observed. Imputation is a process by which a value is assigned either by inference from the value of the products or processes to which it contributes, or by using a fully calibrated demand model to calculate missing values. In some embodiments, market size, market share, or demand can be imputed for past sales periods based on available historical sales data.

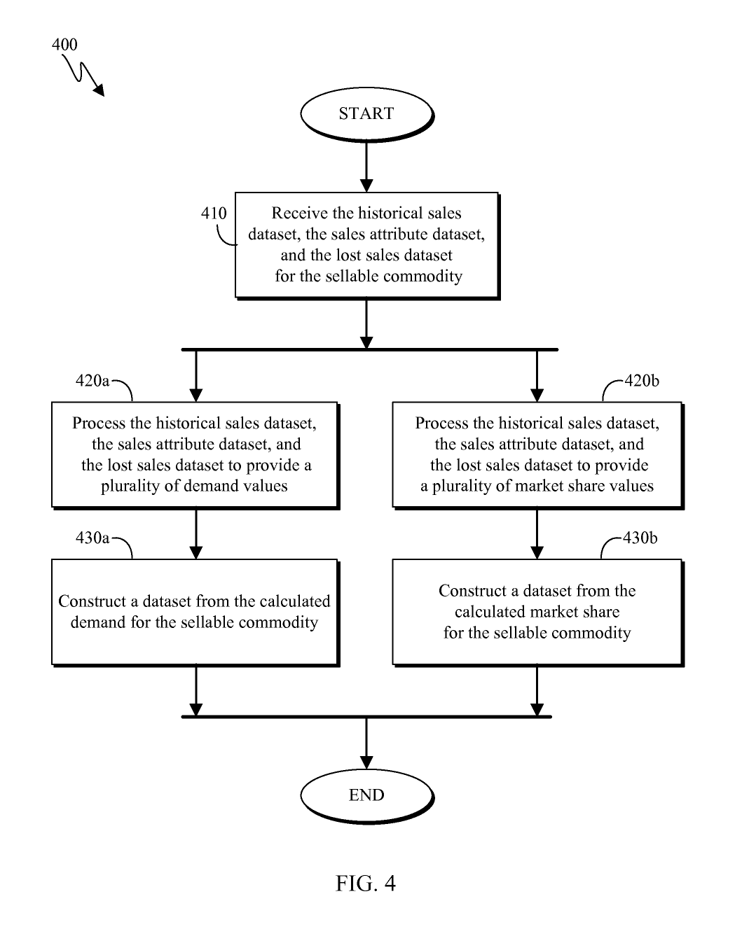

Processing the market size dataset and the market share dataset and/or the demand dataset 260 may include using the best fit optimization module 160 to jointly estimate the parameters of the market size and the market share. The parameters for the market size and the market share may be estimated with respect to the chosen functional model of the demand and observed historical attributes for a plurality of lost market rate probabilities. Processing 260 may also include using the best fit optimization module 160 to provide a set of best fit parameters 168 for the market size and the market share and/or the demand for the set of sellable commodities. Mixed-integer linear programming (MILP) techniques may be employed to choose among the plurality of the lost market rate probabilities, so that the imputations in steps 240 and 250 are consistent with the best fitting procedure. Such an MILP based forecasting system is scalable and can manage the simultaneous calibration of a large number of numerical sensitivity coefficients that can affect consumer purchase rate probabilities (including the scenario where several of these coefficients are subject to logical and user-defined constraints) and produce a solution having a known quality guarantee. The best fitting optimization procedure may minimize a measure of the error between the observed or imputed values and the predicted values for market size and the ratio of market shares or demands, as is depicted in FIG. 4.

Examples of application areas where this estimation method can be used include multi-item and assortment planning demand models, omni-channel demand models, win-probability models for transaction level, requests for quote applications, predicting time of day residential loads, estimating competitor market shares, size profile estimation where stock-outs are prominent, and complementary commodity groups.

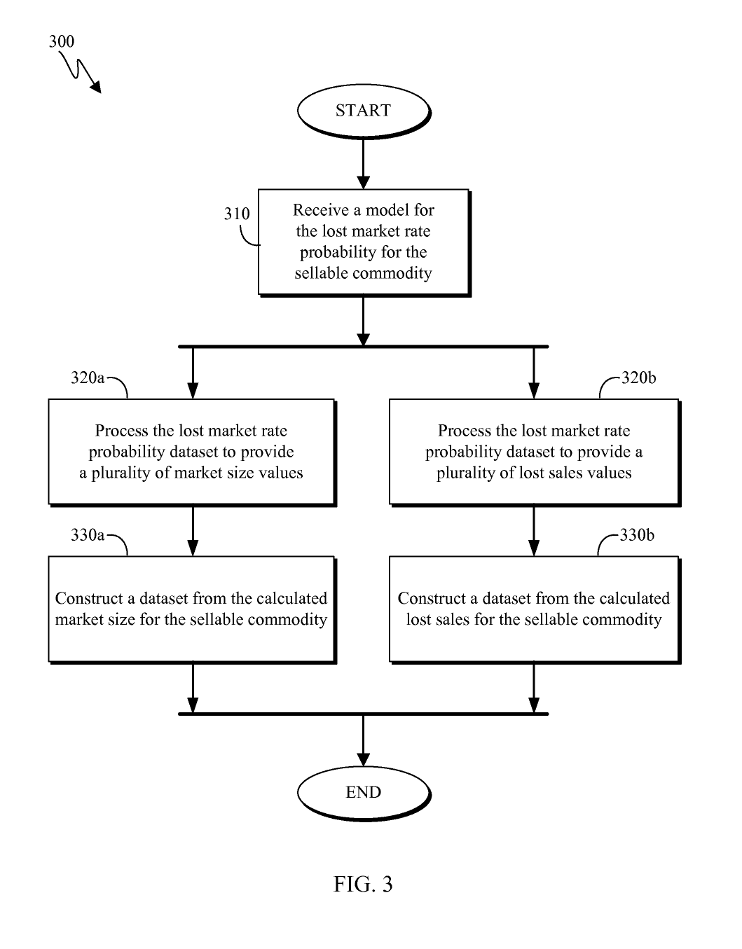

FIG. 3 is an operation dependency diagram 300 for various modules depicted in FIG. 1 including at least one embodiment of the lost-sales forecasting module 130 and at least one embodiment of the market size forecasting module 140. As depicted, the operations include receiving the lost market rate probability dataset for the set of sellable commodities 310, processing the lost market rate probability dataset to provide a market size and lost-sales 320a, 320b, and constructing datasets for the lost-sales and the market size for the set of sellable commodities 330a, 330b. The depicted operations may be executed by the lost-sales forecasting module 130 and the market size forecasting module 140 to jointly determine a lost-sales dataset 138 and a market size dataset 148 for the set of sellable commodities. Jointly determining datasets for lost-sales and market size may comprise joint usage of mixed integer linear programming techniques.

Receiving the dataset for the lost market rate probability for the set of sellable commodities 310 may include receiving the lost market rate probability dataset 132. The lost market rate probability dataset 132 may be used as an input to calculate market size and lost-sales. In some embodiments, receiving the lost market rate probability dataset 132 may include receiving a plurality of values that specify the lost market rate probability.

Processing the lost market rate probability dataset 320a, 320b may include using the plurality of lost market rate probabilities as input to a market size equation and a lost-sales equation. Processing 320a, 320b may yield a plurality of market size values and lost-sales values. Operations 320a and 320b represent simultaneous processes for computing market size and lost-sales, respectively. The market size may be computed according to the equation: θₖₜ=(Σ_{m∈M}(s̅ₘₜ))/(1−fₖ), where “θₖₜ” represents the market size in a period “t” if the lost market rate is fₖ, and “s̅ₘₜ” represents the known historical sales for a commodity choice “m” within the group of sellable commodities “M”. The lost-sales may be computed according to the equation: λₖₜ=(Σ_{m∈M}(s̅ₘₜ)(fₖ))/(1−fₖ), where “λₖₜ” represents the lost-sales in period “t” if the lost market rate is fₖ.

Constructing datasets for the lost-sales and the market size for the set of sellable commodities may include producing datasets 330a, 330b for the lost-sales and the market size, respectively. The lost-sales dataset 138 and the market size dataset 148 may reflect a lost-sales model and a market size model. Constructing a dataset for the market size may include constructing a log-linear model of the market size. Constructing a dataset for the lost-sales 330a, 330b may further comprise disambiguating the lost-sales into isolated individual components. For example, the individual components may be lost-sales due to a no-purchase choice and lost-sales due to a product being purchased from a competitor. Constructing a lost-sales dataset 330a, 330b may additionally comprise constructing datasets for each individual component of the lost-sales. Operations 330a and 330b may be concurrently executed operations.

FIG. 4 is an operation dependency diagram 400 for various modules depicted in FIG. 1 including at least one embodiment of the demand forecasting module 150. As depicted, the operations include receiving the historical sales dataset and the lost-sales dataset for one or more of the sellable commodities 410, processing the received datasets to provide a demand and a market share 420a, 420b and constructing datasets for the demand and the market share for one or more of the sellable commodities 430a, 430b. Jointly producing a demand dataset 156 and a market share dataset 158 may comprise using mixed integer linear programming techniques.

Receiving the historical sales dataset and the lost-sales dataset for one or more sellable commodities 410 may include receiving the lost-sales dataset 138 and the corresponding sales attributes dataset 124. The historical sales dataset 122, the corresponding sales attributes dataset 124, and the lost-sales dataset 138 may be used as inputs to calculate the demand and the market share. In some embodiments, receiving the lost-sales dataset 138 for one or more sellable commodities may include receiving a plurality of values that specify the lost-sales.

Processing the received datasets to provide a plurality of demand values and market share values for the sellable commodity 420a, 420b may include using the previously determined market size and lost-sales along with the historical sales dataset 122 and the corresponding sales attributes dataset 124 to calculate demand and relative market share. In some embodiments, the demand may be computed according to the equation:

Dₘₜ=θₖₜ*Rₘₜ=θₖₜ*((Σ_{m∈M} Aₘ)/(Σ_{m′∈M} A_{m′})

wherein Dₘₜ is the demand for a choice m at time t, θₖₜ is the market size as before, Rₘₜ is the market share for a choice m at time t, Aₘ is the attractiveness of choice m, and m′ represents any choice that is not m. Consumer choice refers to all possibilities of consumer decisions related to buying and not buying a sellable item and depends on a variety of factors including the item attributes, competition and inventory levels. The demand for a consumer choice is as described by the above equation where it is the product of the market size and the respective market share of the choice. Here, the market share itself is the ratio of attractiveness of a choice over the sum of the attractiveness of all other choices. The attractiveness of a choice may be included in the sales attributes dataset 124. Operations 420a and 420b represent the processes for demand and market share, respectively.

Constructing a demand dataset and a market share dataset for one or more of the sellable commodities 430a, 430b may include providing a demand dataset 156 and a market share dataset 158. The demand dataset 156 and the market share dataset 158 may comprise a plurality of values specifying the demand and the market share. In some embodiments, the demand dataset 156 and the market share dataset 158 represent a demand model and a market share model. Operations 430a and 430b may be concurrently executed operations.

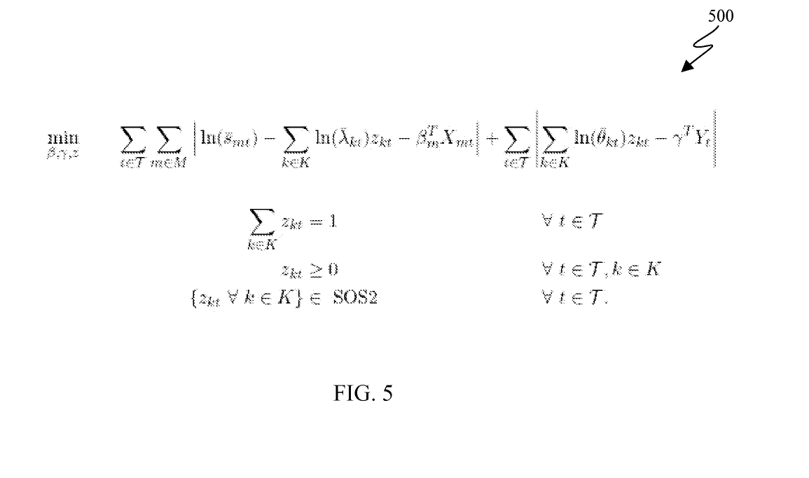

FIG. 5 is an equation diagram depicting one embodiment of a best fit optimization formula 500 suitable for execution by at least one embodiment of the best fit optimization module 160. In the depicted formulas, “t” represents any time within the time period “τ”. “M” is the set of all possible commodity choices, with “m” representing a single choice within the set. “β” is a matrix of coefficients for all the choices “m” and their attributes. Specifically, every row “βₘ” is a row vector of coefficients for the attributes of choice “m”. Xₘₜ is a row vector of historic attribute values at time “t” that impact choice “m”. “θₖₜ” is the market size in period t if the lost market rate is “fₖ”. “γ” is a row vector of coefficients for the attributes of market size. “Yₜ” is a row vector of historic attribute values at time “t” that impact market size. The goal of the method is to identify which lost share “zₖₜ” minimizes the total error between the predicted quantity and the observed quantity. The resulting mathematical formulation can be efficiently solved by the best fit optimization module 160. The best fit optimization module 160 may leverage optimization functions from scalable, multiple-operating system compatible and parallel-computing enabled optimization software packages like IBM-ILOG CPLEX to execute the formula 500, and will quickly produce a global optimal solution for the predicted model with respect to a user-specified error metric.

Many of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a digital processing device or apparatus (such as a processor) configured with software to perform the specified functionality. An identified module may, for instance, comprise one or more physical or logical blocks of computer instructions which may, for instance, be organized as an object, procedure, or function. The executables of an identified module need not be physically located together, but may comprise disparate instructions stored in different locations which, when joined logically together, comprise the module and achieve the stated purpose for the module. For example, a module may be implemented as an on-demand service that is partitioned onto, or replicated on, one or more servers. In some embodiments, the instructions and executed functions correspond to one or more mathematical formulas.

Indeed, the executable code of a module may be a single instruction, or many instructions, and may even be distributed over several different code segments, among different programs, and across several memory and processing devices. Similarly, operational data may be identified and illustrated herein within modules, and may be embodied in any suitable form and organized within any suitable type of data structure. The operational data may be collected as a single data set, or may be distributed over different locations including over different storage devices.

The modules disclosed herein may have fixed functionality that is defined at the time of manufacture or that can be configured with a desired functionality after manufacture. In certain embodiments, one or more of the modules may be configured or reconfigured with codes or instructions stored on a storage medium. For example, a storage medium may take any tangible form capable of storing codes to configure or reconfigure a digital processing apparatus. For example, a storage medium may be embodied by a flash drive, compact disk, digital-video disk, a magnetic tape, a magnetic disk, a punch card, flash memory, integrated circuits, or other memory device suitable for a digital processing apparatus. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A digital processing apparatus such as a computer or a programmable hardware device may store instructions such as program codes, parameters, associated data, and the like on the computer readable medium that when retrieved enable the digital processing apparatus to execute the functionality specified by the modules.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the preceding description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

What is claimed is:

1. A system for forecasting demand, the system comprising:
a data retrieval module configured to retrieve a historical sales dataset and corresponding sales attributes dataset for a set of sellable commodities comprising one or more sellable commodities;
the data retrieval module further configured to retrieve a functional form dataset for determining a market size model and a market share model for the set of sellable commodities;
a market information processing module configured to process the historical sales dataset to provide a lost market rate probability dataset for the set of sellable commodities;
a lost-sales forecasting module configured to process the lost market rate probability dataset to provide a lost-sales dataset as a function of the lost market rate probability for the set of sellable commodities;
a market size forecasting module configured to process the lost market rate probability dataset to provide a market size dataset as a function of the lost market rate probability for the set of sellable commodities; and
a demand forecasting module configured to process the lost-sales dataset and the historical sales dataset to provide a demand dataset and a market share dataset as functions of the lost-sales dataset and the historical sales dataset for the set of sellable commodities.

2. The system of claim 1, further comprising a best fit optimization module configured to process the market size dataset and the market share dataset with a best fit optimization module to provide a set of best fit parameters for the market size and the market share or the demand for the set of sellable commodities.

3. The system of claim 2, wherein the best fit optimization module is further configured to process the market size dataset and the market share dataset using mixed integer linear programming.

4. The system of claim 1, further comprising a data presentation module configured to present datasets to one or more users.

5. The system of claim 1, wherein the demand forecasting module is further configured to process the sales attributes dataset to provide a demand dataset and a market share dataset.

6. The system of claim 1, wherein the market size forecasting module and the lost-sales forecasting module are further configured to process the lost market rate probability model by modeling the market size and the lost-sales as piecewise linear functions of the lost market rate probability.

7. The system of claim 1, wherein the market information processing module is further configured to process the historical sales dataset by modeling the lost market rate probability as a hard-maximum linear approximation of an attractiveness of a no-purchase choice.

8. The system of claim 1, wherein the lost-sales comprise multiple components that can be further isolated by jointly computing a market share of each lost-sales component.

9. The system of claim 1, wherein the historical sales dataset includes incomplete information on lost-sales.

10. A method for forecasting demand, executed by a computer, comprising:
retrieving with a data retrieval module a historical sales dataset and corresponding sales attributes dataset for a set of sellable commodities comprising one or more sellable commodities;
retrieving with the data retrieval module a functional form dataset for determining a market size model and a market share model for the set of sellable commodities;
processing the historical sales dataset with a market information processing module to provide a lost market rate probability dataset for the set of sellable commodities;
processing the lost market rate probability dataset with a market size forecasting module and a lost-sales forecasting module to provide a market size dataset and a lost-sales dataset as functions of the lost market rate probability for the set of sellable commodities; and
processing the lost-sales dataset and the historical sales dataset with a demand forecasting module to provide a demand dataset and a market share dataset as functions of the lost-sales dataset and the historical sales dataset for the set of sellable commodities.

11. The method of claim 10, further comprising processing the market size dataset and the market share dataset with a best fit optimization module to provide a set of best fit parameters for the market size and the market share or the demand for the set of sellable commodities.

12. The method of claim 11, wherein processing the market size dataset and the market share dataset to provide a set of best fit parameters for the market size and the market share or the demand for the set of sellable commodities comprises mixed integer linear programming.

13. The method of claim 10, wherein processing the historical sales dataset to provide a lost market rate probability dataset for the set of sellable commodities comprises global optimization by using an SOS-2 variable.

14. The method of claim 10, wherein processing the lost market rate probability model to provide a market size dataset and a lost-sales dataset as functions of the lost market rate probability for the set of sellable commodities comprises modeling the market size and the lost-sales as piecewise linear functions of the lost market rate probability.

15. The method of claim 10, wherein the historical sales dataset includes incomplete information on lost-sales.

16. The method of claim 10, wherein the lost market rate probability is modeled as a hard-maximum linear approximation of an attractiveness of a no-purchase choice.

17. The method of claim 10, wherein the lost-sales comprise multiple components that can be further isolated by jointly computing a market share of each lost-sales component.

18. The method of claim 10, wherein processing the lost-sales dataset and the historical sales dataset with a demand forecasting module further comprises processing the sales attributes dataset to provide a demand dataset and a market share dataset.
